(19) United States
(12) Patent Application Publication
(10) Pub. No.: US 2013/0170839 A1
(43) Pub. Date: Jul. 4, 2013

(54) WIRELESS REMOTE CONTROL SYSTEMS AND METHODS FOR BATHROOM DEVICES

(71) Applicant: Shanghai Kohler Electronics, Ltd, Shanghai (CN)

(72) Inventor: Fangsheng Yuan, Shanghai (CN)

(73) Assignee: Shanghai Kohler Electronics, Ltd., Shanghai (CN)

(21) Appl. No.: 13/709,691

(22) Filed: Dec. 10, 2012

(30) Foreign Application Priority Data
Dec. 28, 2011 (CN) 201120560368.5

(51) Int. Cl. H04B 10/50

(52) U.S. Cl. CPC H04B 10/50
USPC 398/107; 398/106

(57) ABSTRACT

The present application relates to a communication system for a bathroom product such as a toilet. The communication system includes a remote control device and a host device that directly controls the bathroom product. The remote control device includes an infrared module, a first RF communication module, and a first microcontroller connected to the infrared module and the first RF communication module. The host device includes a second RF communication module and a host microcontroller. The first microcontroller uses the infrared module to detect whether a person has entered the proximity of the remote control device. The first microcontroller is configured to cause the first RF communication module to activate, from a deactivated state, in response to the infrared module and the first microcontroller detecting that a person has entered the proximity of the remote control device.

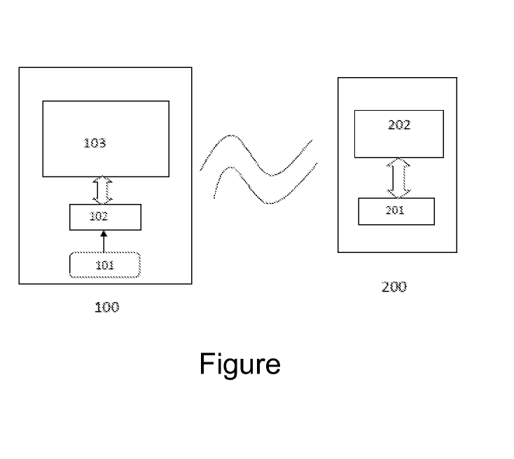

### CROSS-REFERENCE TO RELATED PATENT APPLICATIONS

This application claims the benefit of and priority to Chinese Patent Application No. 201120560368.5, filed Dec. 28, 2011, the entirety of which is incorporated herein by reference.

### BACKGROUND

This application relates to a wireless (e.g., Bluetooth) communication system for use with bathroom devices (e.g., faucets, toilets, etc.).

Conventionally, the remote control of traditional bathroom products or devices (e.g., faucets, toilets, etc.) is primarily performed through infrared communication. Infrared communication relies on straight-line transmission and has high directional requirements. In rooms with relatively confined space and/or obstacles, infrared communication can suffer from high error rates and unreliable communication. Furthermore, the limited volume of data that can be transmitted by infrared communication and the fact that most infrared systems only allow one-way communication have presented challenges.

For example, using infrared communications, many conventional toilets or other bathroom devices/fixtures allow only simple keypad control. Once a person enters the bathroom and sits on such a conventional toilet, because they face away from the toilet, it is difficult to point a hand-held infrared terminal directly at the toilet. Therefore, a person sitting on the toilet must point the remote control at the wall or ground in front of them, and attempt to transmit a remote control signal to the toilet via reflection off the wall or ground. If the wall or the ground is uneven or harbors material that absorbs infrared rays, such a method may be highly unreliable or fail to work. In many cases, multiple manipulations are necessary to carry out remote control, which can make the use of smart toilets difficult to control. These and other features of conventional infrared devices and conventional smart toilets have presented challenges.

### SUMMARY OF THE INVENTION

The present invention generally relates to a wireless communication system for a bathroom product (e.g., smart toilet, remote control plumbing fixture.

An embodiment of the present application relates to a communication system for a bathroom product such as a toilet. The communication system includes a remote control device and a host device. The remote control device includes an infrared module, a first RF communication module, and a first microcontroller connected to the infrared module and the first RF communication module. The host device includes a second RF communication module and a host microcontroller. The first microcontroller uses the infrared module to detect whether a person has entered the proximity of the remote control device. The first microcontroller is configured to cause the first RF communication module to activate, from a deactivated state, in response to the infrared module and the first microcontroller detecting that a person has entered the proximity of the remote control device. In the deactivated state, the first RF communication module may draw little to no battery power. In an activated state, the first RF communication may draw power and be ready for bidirectional data communication. The first microcontroller and/or the first RF communication module may be configured to set the first RF communication module into the deactivated state (e.g., low power state, sleep state, etc.).

The bathroom product may be a toilet and the host device may be embedded within or on the toilet. The host device may be configured to affect at least one toilet function based on communications received at the second RF communication module from the remote control device.

The remote control device may be a handheld remote control including a user input device (e.g., a keypad, a touch screen, etc.). In response to input received at the user input device, the remote control device (e.g., the remote control device's first microcontroller and first RF communication module) can cause commands to be transmitted from the first RF communication module to the host device's second RF communication (e.g., for causing the host device to affect the at least one toilet function).

An embodiment of the present invention relates to a communication system for a bathroom product (e.g., a toilet, a bidet, a toilet bidet, a smart toilet, a shower, etc.). The communication system includes a remote control device (i.e., slave device, handheld remote control, wall-mounted remote control, etc.). The remote control device includes an infrared module (e.g., infrared transmitter and receiver), a first RF communication module (e.g., Bluetooth communication module, WiFi communication module, etc.) and a first microcontroller. The infrared module is unidirectionally connected to the first microcontroller (e.g., the infrared module provides information regarding detections to the first microcontroller). The first RF communication module may be bidirectionally interconnected with the first microcontroller. The communication system further includes a host device (e.g., a device having a wired or embedded connection with a controller for the bathroom product). The host includes a second RF communication module and a host microcontroller. The second RF communication module may be bidirectionally interconnected with the host microcontroller. A paired communication link is established between the first RF communication module and the second RF communication module.

Embodiments of the present invention relate to a remote control device for providing commands via an RF communications protocol to a bathroom product. The remote control device includes an infrared module configured to detect at least one of human movement or human presence in proximity (e.g., in the same room, within a yard, within a few feet, within the line of sight of, within a detectable distance, etc.) to the remote control device. The remote control device further includes an RF communications module. The RF communications module is bidirectionally connected to the microcontroller and configured for communication via the RF communications protocol to an RF communications module coupled to the bathroom product. In response to user interface commands (e.g. keypad commands, touch commands, etc.) received at the a user interface (e.g., a keypad, a touch pad, etc.) of the remote control device, the microcontroller causes a command to be transmitted via the RF communications protocol and via the RF communications module to the RF communications module coupled to the bathroom product. The microcontroller is configured to cause the RF communications module to activate, e.g., from a default deactivated state, in response to the infrared module detecting the human movement or presence.

### BRIEF DESCRIPTION OF THE FIGURE

The FIGURE is a block diagram depicting the communication system for a bathroom product according to an exemplary embodiment.

### DETAILED DESCRIPTION

The FIGURE is a block diagram depicting a communication system for a bathroom product (e.g., toilet, smart toilet, toilet bidet, controllable toilet, etc.). The communication system includes a remote control device 100 and a host device 200. The remote control device 100 may be a handheld remote control device or a wall-mounted remote control device physically separate from the bathroom product and not wired to the bathroom product. The host device 200 may be embedded within the bathroom product and configured to affect the operation of the bathroom product. For example, the host device 200 can be a circuit board wired to sensors, actuators, motors, or other controllable devices of the bathroom product. The remote control device 100 is configured to have a default state wherein its RF communication capability is deactivated or asleep until human presence is detected (e.g., via infrared detection).

Referring further to the FIGURE, the remote control device 100 includes an infrared module 101, a first RF communication module 103, and a first microcontroller 102. The first microcontroller 102 is connected to the infrared module 101 and the first RF communication module 103. The host device 200 includes a second RF communication module 201 and a host microcontroller 202. The first microcontroller 102 uses the infrared module 101 to detect whether a person has entered the proximity of the remote control device.

The first microcontroller 102 is configured to cause the first RF communication module 103 to activate, from a deactivated state, in response to the infrared module 101 and the first microcontroller 102 detecting that a person has entered the proximity of the remote control device 100. In the deactivated state, the first RF communication module 103 may draw little to no battery power. In an activated state, the first RF communication module 103 may draw power and be ready for bidirectional data communication. The first microcontroller 102 and/or the first RF communication module 103 may be configured to set the first RF communication module 103 into the deactivated state (e.g., low power state, sleep state, etc.) after a period of time (e.g., after a period of time with no human presence detections by the infrared module 101.

The bathroom product may be a toilet and the host device 200 may be embedded within or on the toilet. The host device 200 may be configured to affect at least one toilet function based on communications received at the second RF communication module 201 from the remote control device 100.

The remote control device 100 may be a handheld remote control including a user input device (e.g., a keypad, a touch screen, etc.). In response to input received at the user input device, the remote control device 100 (e.g., the remote control device's first microcontroller 102 and first RF communication module 103) can cause commands to be transmitted from the first RF communication module 103 to the host device 200's second RF communication module 201 (e.g., for causing the host device to control or affect the at least one toilet function, for controlling a bidet function, for adjusting temperature of bidet spray, etc.).

First RF communication module 103 may be a Bluetooth compatible RF communications module. Infrared module 101 may be unidirectionally connected to first microcontroller 102. First RF communication module 103 may be bidirectionally interconnected with first microcontroller 102, to provide two-way data exchange between first RF communication module 103 and first microcontroller 102.

Host device 200 includes second RF communication (e.g., Bluetooth) module 201 and host microcontroller 202. Second RF communication module 201 may be bidirectionally interconnected with host microcontroller 202, to provide two-way data exchange between second RF communication module 201 and host microcontroller 202. A paired communication link may be established between first RF communication module 103 and second RF communication module 201 (e.g., when the first RF communication module 103 is activated in response to infrared detection of a human near the remote control device 100). Via the communication link, the system can complete transmission of communication instructions between the two RF communication modules 103, 201.

According to an exemplary embodiment, when the remote control device 100 is not in use, first RF communication module 103 is deactivated (e.g., partially off, fully off, deactivated for communication, powered down, in a low power state, asleep, etc.). In such a state, remote control device 100 (e.g., a battery powered handheld device, a battery powered wall-mounted device, a mains-powered wall-mounted device, etc.) has no communication with the outside world and power savings is achieved.

When the bathroom product begins to be used or is about to be used, the infrared module 101 may detect a human (e.g., within detectable proximity, within a line of sight of the infrared transmission, capable of being detected by the infrared module's transmitter and receiver, etc.). If infrared module 101 detects a need to activate the bathroom product (for example, a person entering the bathroom is detected), infrared module 101 wakes up first microcontroller 102, and first RF communication module 103 is activated. After a period of time during which the remote control is not used and the infrared module 101 does not detect a human, the first RF communication module 103 can return to a deactivated state. This switching to the deactivated state may be controlled by first microcontroller 102. Therefore, if the person does not manipulate first microcontroller 102 (e.g., via a keypad), no data will be sent to host 200. At such time, first RF communication module 103 is in a low-power standby state, with its external circuit closed.

If the person manipulates remote control microcontroller 102 (e.g., via a keypad or other user interface device that is a part of remote control device 100 and coupled to the microcontroller 102) and thereby wishes to send data (e.g., commands, queries, requests, etc.) to host 200, a initialization can occur within the microcontroller 102 which wakes up or otherwise activates first RF communication module 103. First RF communication module 103 can then send instruction data to second RF communication module 201. Second RF communication module 201 can then provide the received instruction data to host microcontroller 202. Host microcontroller 202 can then manipulate the bathroom product according to the received instruction data.

In an exemplary embodiment, parameters are preset in the two devices 100, 200 (e.g., in their RF communication modules 103, 201, in their microcontrollers 102, 202, in memory of the devices, etc.) so that a communications link is automatically established after the remote control device 100 powers on the first RF communication module 103.

Embodiments of the present application advantageously provide for the remote control of bathroom products (e.g., a toilet, a toilet bidet, a bidet, a music player in the bathroom, a shower system, etc.) by using bi-directional RF communication (e.g., advantageously utilizing the RF communication such as Bluetooth to increase the volume or speed of data transmitted while allowing omnidirectional transmission/reception). Embodiments of the present invention also use infrared detection to turn the RF communication module 103 of the remote control device (e.g., handheld remote control, etc.) on or off. Advantageously, the RF communication module 103 of the remote control device 100 may not be turned on (e.g., and thereby using battery power) until infrared detection detects behavior that may be a person in the bathroom. In an exemplary embodiment, the RF communication modules 103, 201 of the remote control device 100 and the host device 200 are automatically paired when the RF communication module 103 of the remote control device 100 is actives (e.g., due to detected movement or human presence detected by the infrared module of the remote control device).

Embodiments of the present application generally relate to the use of RF communication such as Bluetooth communication in the intelligent remote control of bathroom products (e.g., a toilet). RF communication such as Bluetooth communication can be omnidirectional. RF communication such as Bluetooth communication can also support two-way transmission and data exchange. Large quantities of data may be transmitted by RF communication protocols such as Bluetooth communication protocols, and at fast speeds. Many RF communication protocols such as Bluetooth also support one-to-many data communication and relatively open development. Applicants have identified that current Bluetooth communication products, as well as communication via other RF communication protocols, have certain drawbacks. For example, the power consumption of Bluetooth communications is considerable when battery power is used to power the Bluetooth-enabled device. Some Bluetooth remote controls may only be used a few days or even hours, which greatly limits the application of Bluetooth communication in handheld terminal applications. By comparison, traditional infrared communication has low power consumption, and infrared remote controllers last longer. Communication systems for a bathroom product as described herein may advantageously provide the communication of large volumes of data at high speeds while ensuring that the remote control of bathroom products could last for a longer period of time.

The communication system of the present application may be used in for smart toilets (e.g., having remote control features), bidets, and other types of toilet devices. However, it may be understood that the infrared Bluetooth communication device can also be used in other bathroom products.

What is claimed is:

1. A communication system for a bathroom product, comprising:
a remote control device comprising an infrared module, a first RF communication module, and a first microcontroller connected to the infrared module and the first RF communication module;
a host device comprising a second RF communication module and a host microcontroller;
wherein the first microcontroller uses the infrared module to detect whether a person has entered the proximity of the remote control device, and wherein the first microcontroller is configured to cause the first RF communication module to activate, from a deactivated state, in response to the infrared module detecting that a person has entered the proximity of the remote control device.

2. The communication system of claim 1, wherein the bathroom product is a toilet and the host device is embedded within or on the toilet; and wherein the host device is configured to affect at least one toilet function based on communications received at the second RF communication module from the remote control device.

3. The communication system of claim 2, wherein the remote control device is a handheld remote control comprising a user input device and configured to, in response to input received at the user input device, cause commands to be transmitted from the first RF communication module to the second RF communication for causing the host device to affect the at least one toilet function.

4. The communication system of claim 1, wherein the first microcontroller causes the first RF communication module to deactivate after a period of time.

5. The communication system of claim 1, wherein the first microcontroller causes the first RF communication module to be deactivated by default.

6. A method for operating a remote control for a bathroom product, comprising:
sensing motion using a sensing module of the remote control;
in response to the sensed motion, activating an RF communication module of the remote control and initiating bi-directional RF communication between the remote control and the bathroom product.

7. The method of claim 6, further comprising:
deactivating the RF communication module when the sensing module has not sensed motion for a period of time.

8. The method of claim 6, wherein the bathroom product is at least one of a toilet, toilet bidet, or bidet.

9. The method of claim 6, wherein the activation is conducted by a microcontroller connected between the sensing module and the RF communication module.

10. The method of claim 6, further comprising:
in response to keypad input, transmitting a command from the RF communication module to the bathroom product via the initiated bi-directional RF communication.

11. An RF communication system for a bathroom product, comprising:
a remote control comprising an infrared module, a first RF communication module and a first microcontroller, wherein the infrared module is unidirectionally connected to the first microcontroller, and the first RF communication module is bidirectionally interconnected with the first microcontroller; and
a host physically coupled or wired to the bathroom product, said host comprising a second RF communication module and a host microcontroller, wherein the second RF communication module is bidirectionally interconnected with the host microcontroller, and a paired communication link is established between the first RF module and the second RF module in response to motion detected by the infrared module.

12. The RF communication system of claim 11, wherein the bathroom product is at least one of a toilet, a toilet bidet, and a bidet.

13. The RF communication system of claim 11, wherein the remote control is a handheld terminal having at least one of a keypad and a touch pad.

14. The RF communication system of claim 11, wherein the host is embedded within a casing of the bathroom product.

15. The RF communication system of claim 11, wherein the first microcontroller is configured to hold the first RF communication module in a deactivated state by default.

16. The RF communication system of claim 11, wherein the first microcontroller is configured to cause the first RF communication module to return to a deactivated state after a predetermined period of time elapses from the last motion sensed by the infrared module.

17. The RF communication system of claim 11, wherein the RF communication module is an RF communication module configured to communicate according to a BLUETOOTH communication protocol.

18. The RF communication system of claim 11, wherein the remote control is a battery powered remote control unit.

19. The RF communication system of claim 11, wherein the remote control is a wall-mounted remote control.

20. The RF communication system of claim 11, wherein the motion triggered activation of the bidirectional RF interconnection reduces the response time to a command received at the remote control and to be transmitted via the bidirectional RF interconnection to the bathroom product.
